(19) United States
(12) Patent Application Publication
(10) Pub. No.: US 2016/0231176 A1
(43) Pub. Date: Aug. 11, 2016

(54) LIGHT IRRADIATION DEVICE HAVING POLARIZATION MEASURING MECHANISM

(71) Applicants: IWASAKI ELECTRIC CO., LTD., Tokyo (JP); POLARIZATION SOLUTIONS, LLC, Somerset, NJ (US)

(72) Inventors: Hirokazu Ishitobi, Gyoda City (JP); Xuegong Deng, Piscataway, NJ (US); Thomas Wray Tombler, JR., Somerset, NJ (US)

(73) Assignees: POLARIZATION SOLUTIONS, LLC, Somerset, NJ (US); IWASAKI ELECTRIC CO., LTD., Tokyo (JP)

(21) Appl. No.: 14/615,015

(22) Filed: Feb. 5, 2015

(51) Int. Cl. G01J 4/04; F21V 9/14

(52) U.S. Cl. CPC G01J 4/04; F21V 9/14

(57) ABSTRACT

A light irradiation device for irradiating polarized light having a light source, a device-side polarizer for polarizing light of the light source and a measuring device that measures a polarization axis of the light polarized by the device-side polarizer is provided, an extinction ratio of the device-side polarizer being set to 100:1 or more.

### FIELD OF THE INVENTION

The present invention relates to a light irradiation device having a polarization measuring mechanism for measuring the angle (direction or orientation) of a polarization axis.

### BACKGROUND OF THE INVENTION

There is known a technique called as photo-alignment (photo-orientation) for applying polarized light to photo-alignment film or a photo-alignment layer (hereinafter referred to as “photo-alignment film”) to optically align (orientate) the film or layer. This photo-alignment technique has been widely applied to alignment of liquid crystal alignment film provided to a liquid crystal display element in a liquid crystal display panel or the like.

A light irradiation device (photo-alignment device) used for the photo-alignment generally has a light source for emitting light and a polarizer for polarizing light incident thereto, and is configured so that the light from the light source is passed through the polarizer to obtain polarized light (see JP-A-2004-163881, for example).

The extinction ratio and the dispersion of polarization axis distribution have been known as factors of polarized light which affect the quality of photo-alignment, and it is important that the above two factors have been adjusted with high precision in the light irradiation device for photo-alignment. Various techniques have been hitherto proposed for measurement of the extinction ratio and the polarization axis (see JP-A-2004-226209, JP-A-2005-227019, JP-A-2007-127567, for example).

In order to obtain optically aligned liquid crystal film having high quality by using the photo-alignment device, it is necessary that the extinction ratio is high and the polarization axis is adjusted with an accuracy of 0.1° or less in error for example. In order to adjust the polarization axis with an accuracy of 0.1° or less in error, the measurement accuracy of the polarization axis is designed to be within 0.01° in error. However, in the conventional techniques, the measuring device itself has an error (for example, about 0.01°), and thus it has been difficult to adjust the polarization axis with an accuracy satisfying the above requirement.

The present invention has been implemented under such circumstances, and has an object to provide a light irradiating device having a polarization measuring mechanism (system) that is capable of measuring the angle (direction or orientation) of the polarization axis of polarized light to be applied to a target object with high precision.

### SUMMARY OF THE INVENTION

In order to attain the above object, according to a first aspect of the present invention, a light irradiation device for irradiating polarized light comprises: a light source, a device-side polarizer that polarizes light of the light source, the device-side polarizer having an extinction ratio of 100:1 or more at one or more wavelengths of light, and a measuring device that is used to determine a polarization axis of the light polarized by the device-side polarizer, wherein the measuring device may be moved away or separated from the rest of the light irradiation device.

In the above construction, the measuring device may have a detection-side polarizer, and the measuring device may detect light transmitted through the device-side polarizer and the detection-side polarizer in this order while changing a polarization-axis angle of the detection-side polarizer. In one embodiment, one obtains a variation curve representing a periodical variation of a light amount of the light detected while changing the polarization-axis angle of the detection-side polarizer, and determine the polarization axis of the device-side polarizer on the basis of the variation curve.

In the above construction, the measuring device may change the polarization-axis angle of the detection-side polarizer by turning the detection-side polarizer.

In the above construction, the light irradiation device may further comprise a rotary actuator that turns the detection-side polarizer to change the polarization-axis angle of the detection-side polarizer.

In the above construction, the measuring device may have a plurality of detection-side polarizers having different polarization-axis angles at a detection side, and the polarization-axis angle at the detection side may be changed by moving the plurality of detection-side polarizers while making the light transmitted through the device-side polarizer pass through each of the detection-side polarizers in series.

According to a second aspect of the present invention, a light irradiation device for irradiating polarized light comprises: a light source; a device-side polarizer that polarizes light of the light source along a polarization axis thereof and has an extinction ratio of 100:1 or more; a detection-side polarizer that transmits the light polarized by the device-side polarizer; and a polarization-axis detector that detects light transmitted through the device-side polarizer and the detection-side polarizer in this order while changing a polarization-axis angle of the detection-side polarizer, obtains a variation curve representing a periodical variation of a light amount of the light detected at each polarization-axis angle of the detection-side polarizer, and determines a polarization-axis angle of the device-side polarizer on the basis of the variation curve.

In the above construction, the polarization-axis detector may have a plurality of detection-side polarizers having different polarization-axis angles at a detection side, and a driving mechanism that moves the plurality of detection-side polarizers while making the light transmitted through the device-side polarizer pass through each of the detection-side polarizers in series.

According to a third aspect of the present invention, a light irradiation device for irradiating polarized light comprises a light source, and more than one device-side polarizer that polarizes light of the light source with an extinction ratio value of at least 100:1 at one or more wavelengths of the light, wherein the device-side polarizers are aligned to a predetermined polarization directions within 0.1 deg. or less in error.

In the above construction, the direction of the polarization direction may be determined by a measuring device that is used to determine a polarization axis of the light polarized by each of the device-side polarizers, and may be moved away or separated from the light irradiation device.

According to the present invention, the extinction ratio of the device-side polarizer is set to 100:1 or more, and thus the polarization-axis angle of the polarized light to be applied to the target object can be measured with high precision.

### BRIEF DESCRIPTION OF THE DRAWINGS

FIG. 1 is a schematic diagram showing a photo-alignment device having a polarization measuring mechanism according to an embodiment of the present invention;

FIG. 2 is a diagram showing the construction of the photo-alignment device and the polarization measuring mechanism;

FIG. 3 is a schematic diagram showing the construction of a detector;

FIG. 4 is a schematic diagram showing a variation curve of detected light in one of the current embodiments;

FIGS. 5A and 5B are schematic diagrams showing the variation curve of the detected light, wherein FIG. 5A represents the variation curve when the difference between the minimum light amount and the maximum light amount is small, and 5B represents the variation curve when the difference between the minimum light amount and the maximum light amount is large;

FIG. 6 is a graph showing the relationship between the extinction ratio of a device-side wire-grid polarizer and the error of the polarization axis of polarized light which is measured by a polarization measuring device and is to be applied to a target object;

FIG. 7 is a graph showing the relationship between the extinction ratio of a device-side wire-grid polarizer and the error of the polarization axis of polarized light which is measured by the polarization measuring device and is to be applied to the target object;

FIG. 8 is a graph showing the relationship between the extinction ratio of a device-side wire-grid polarizer and the error of the polarization axis of polarized light which is measured by the polarization measuring device and is to be applied to the target object; and

FIG. 9 is a schematic diagram showing a detector according to a modification of the present invention.

### DETAILED DESCRIPTION OF THE INVENTION

### Embodiments

Embodiments according to the present invention will be described hereunder with reference to the drawings.

In the following description, a photo-alignment device for optically aligning liquid crystal film or the like is representatively described as a light irradiating device according to the present invention. However, the light irradiating device of the present invention is not limited to the photo-alignment device, but may be any device insofar as the device emits polarized light.

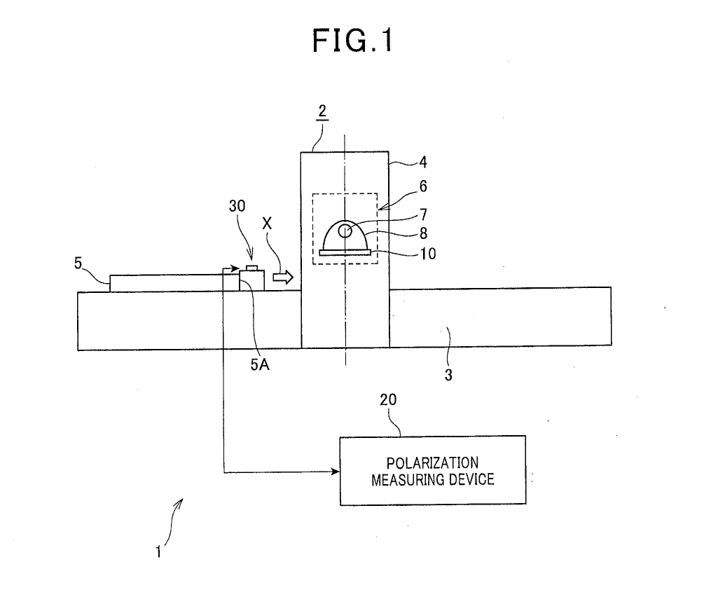

FIG. 1 is a schematic diagram showing a photo-alignment device (light irradiating device) 2 having a polarization measuring mechanism (system) 1 according to the embodiment.

In FIG. 1, the photo-alignment device (light irradiation device) 2 is a device for applying polarized light to a strip-shaped photo-alignment film as a photo-alignment target to optically align the photo-alignment film, and the polarization measuring mechanism 1 measures polarization characteristics of the polarized light of the photo-alignment device 2. The polarization axis and extinction ratio of the polarized light of the photo-alignment device 2 are measured as the polarization characteristics.

The photo-alignment device 2 has a surface plate 3 having a vibration control structure, an irradiator setup stand 4, and a work stage 5 on which a photo-alignment target is mounted.

The irradiator setup stand 4 is a box-shaped member that is disposed at a predetermined height above the surface plate 3 so as to lay across laterally in the width direction of the surface plate 3 (in a direction perpendicular to the linear-motion direction of a linear-motion mechanism described later), and both the ends of the irradiator setup stand 4 are fixed to the surface plate 3. The irradiator setup stand 4 contains an irradiator 6, and the irradiator 6 irradiates polarized light vertically downwards. In order to separate vibration caused by cooling of the irradiator 6 from vibration following movement of the work stage 5, the irradiator setup stand 4 may be disposed separately from the surface plate 3 instead of fixing the irradiator setup sand 4 to the surface plate 3.

The surface plate 3 is internally provided with a linear motion mechanism (not shown) for feeding the work stage 5 on the surface of the surface plate 3 along the linear-motion direction X so that the work stage 5 passes just under the irradiator 6. When the photo-alignment target is optically aligned, the photo-alignment target mounted on the work stage 5 is fed together with the work stage 5 by the linear motion mechanism, and passed just under the irradiator 6. The photo-alignment target is exposed to polarized light when passing just under the irradiator 6, whereby the photo-alignment film is aligned.

The irradiator 6 has a lamp 7 as a light source, a reflection mirror 8 and a polarizer unit 10, and irradiates converged polarized light vertically downwards (90 deg. to the workpiece), or having a predefined inclination other than 90 deg., for example, 45 deg. rotating along the direction transverse to the moving direction of stage 5.

A discharge lamp may be used as the lamp 7. In this embodiment, a straight pipe type (rod-shaped) ultraviolet lamp which is designed to extend by a length corresponding to the width of the photo-alignment target or more is used as the lamp 7. The reflection mirror 8 is a cylindrical concave reflection mirror which is elliptical in section and extends along the longitudinal direction of the lamp 7, and it converges the light of the lamp 7 and applies the converged light to the polarizer unit 10.

The polarizer unit 10 is disposed between the reflection mirror 8 and the photo-alignment target, and polarizes light to be applied to the photo-alignment target. The photo-alignment film of the photo-alignment target is irradiated with this polarized light, whereby the photo-alignment film is aligned in conformity with the polarization axis angle (direction) of the polarized light.

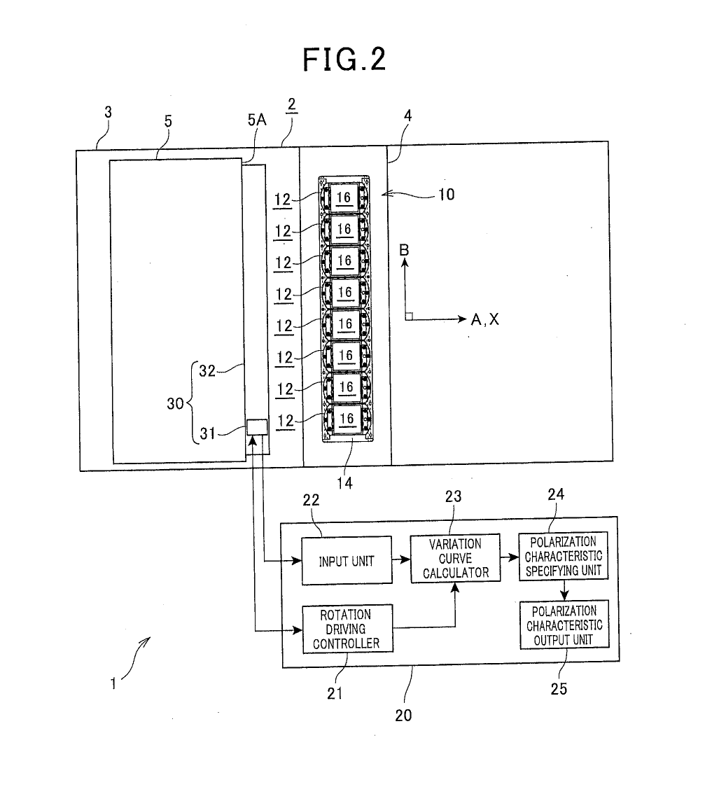

FIG. 2 is a diagram showing the construction of the polarization measurement system 1 together with a plan view of the photo-alignment device 2. In order to facilitate understanding of the construction of the polarizer unit 10, only the polarizer unit 10 is illustrated in the irradiator setup stand 4 in FIG. 2.

As shown in FIG. 2, the polarizer unit 10 has plural unit polarizer units 12, and a frame 14 in which these unit polarizer units 12 are laterally arranged side by side in a line. The frame 14 is designed as a plate-like frame in which the respective unit polarizer units 12 are arranged to be continuously adjacent to one another. The unit polarizer unit 12 has a wire grid polarizer (device-side polarizer) 16 which is designed in the form of a substantially rectangular plate.

In this embodiment, each unit polarizer unit 12 supports the wire grid polarizer 16 so that the wire direction A is parallel to the linear-motion direction X of the work stage 5, and the direction perpendicular to the wire direction A is coincident with the arrangement direction B of the wire grid polarizers 16.

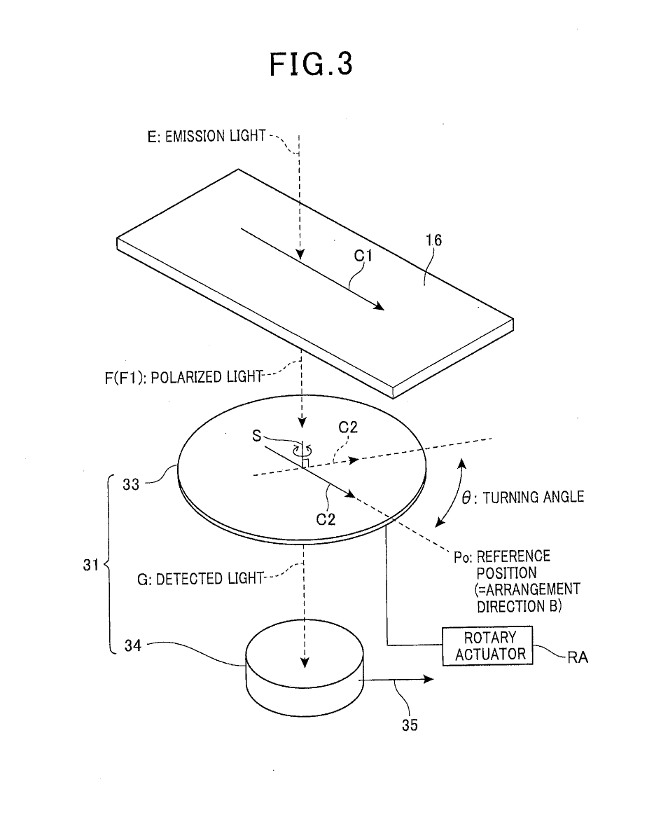

The wire grid polarizer 16 is a kind of linear polarizer which reflects or absorbs an incident light component parallel to the wire direction A and transmits another incident light component perpendicular to the wire direction A, thereby obtaining linearly polarized light. In this wire grid polarizer 16, the direction perpendicular to the wire direction A is defined as a polarization axis C1 (FIG. 3) of the linear polarization, and the polarization axis C1 is set to be aligned with the arrangement direction B in this embodiment. As described above, since the lamp 7 is designed like a rod, light is incident to the wire grid polarizer 16 from various directions (at various angles). However, even when light is obliquely incident to the wire grid polarizer 16, the wire grid polarizer 16 linearly polarizes and transmits the incident light insofar as the direction of the incident light is matched with the direction of the polarization axis C1 (transmission axis).

The wire grid polarizer 16 is supported by the unit polarizer unit 12 to be turnable (rotatable) within a plan around the normal direction thereof as a turning (rotating) axis so that the direction of the polarization axis C1 can be finely adjusted. All the unit polarizer units 12 are finely adjusted so that the polarization axes C1 of the wire grid polarizers 16 are aligned with the arrangement direction B, thereby obtaining polarized light whose polarization axis C1 is aligned over the whole length in the major axis direction of the polarizer unit 10 with high precision, whereby high-quality photo-alignment can be performed.

In this embodiment, as shown in FIG. 1, the polarization measuring mechanism 1 contains the polarization measuring device (measuring device) 20, and a measuring unit 30. The measuring unit has a detector 31 for detecting polarized light, and the polarization measuring device 20 measures the polarization axis and extinction ratio of the polarized light on the basis of the detection result of the polarized light which is obtained by the detector 31.

In order to facilitate individual measurement of each wire grid polarizer 16, the measuring unit 30 has a linear guide 32 for guiding the detector 31 along a line while the guide direction is set in parallel to the arrangement direction B as shown in FIG. 2. During the measurement of the polarized light, the linear guide 32 is fed just under the polarizer unit 10 while connected to the side surface 5A at the travel direction side of the work stage 5, or the linear guide 32 is mounted on the surface of the surface plate 3 so as to be located just under the polarizer unit 10. The detector 31 is moved or is made to move by itself along the linear guide 32 so that the detector 31 is located just below a wire grid polarizer 16 as a fine adjustment target, and detects polarized light transmitted through the wire grid polarizer 16 at that position, thereby measuring the polarized light.

FIG. 3 is a schematic diagram showing the construction of the detector 31.

The detector 31 has a detection-side polarizer 33, and a photodetection sensor 34.

The detection-side polarizer 33 is a linear polarizer (plate-like, disc-shaped in the example of FIG. 3) for photodetection having a polarization axis C2, which is also called as an analyzer. Polarized light F which is transmitted through the wire grid polarizer 16 and linearly polarized is incident to the detection-side polarizer 33 to be linearly polarized. Any polarizer may be used as the detection-side polarizer 33 insofar as it is a linear polarizer, and for example a wire grid polarizer may be also used for the detection-side polarizer 33.

The photodetection sensor 34 photodetects detection light G which is linearly polarized along the polarization axis C2 of the detection-side polarizer 33 and outputs a detection signal 35 representing the light amount I of the detection light G to the polarization measuring device 20.

In one of the preferred embodiments, the detection-side polarizer 33 is disposed to be freely turnable (rotatable) over at least one revolution around the normal direction S thereof as the turning (rotation) axis. The turning (rotation) of the detection-side polarizer 33 is specified by a turning (rotation) angle θ from a reference position P0. In this embodiment, the reference position P0 (or the direction of the reference position P0) is set so that the direction of the polarization axis C2 is coincident with the arrangement direction B of the wire grid polarizers 16. That is, when the detector 31 is set onto the linear guide 32 and the detection-side polarizer 33 is set to the reference position P0, the polarization axis C2 of the detection-side polarizer 33 is set to face the arrangement direction B.

The polarization measuring device 20 measures the polarization axis F1 and the extinction ratio of the polarized light F. In one of the preferred embodiments, the measurements are based on the periodic variation of the light amount of the detection light G during one rotation of the detection-side polarizer 33. Specifically, as shown in FIG. 2, the polarization measuring device 20 has a rotation driving controller 21, an input unit 22, a variation curve calculator 23, a polarization characteristic specifying unit 24 and a polarization characteristic output unit 25. The polarization measuring device 20 may be performed by making a personal computer execute computer-readable programs for implementing the respective units shown in FIG. 2, for example.

The rotation driving controller 21 controls the rotation of the detection-side polarizer 33 of the detector 31. Specifically, the detector 31 has a rotary actuator RA for turning (rotating) the detection-side polarizer 33, and the rotation driving controller 21 controls the rotary actuator to turn (rotate) the detection-side polarizer 33, whereby the polarization axis C2 is set to be aligned with the direction of a predetermined turning (rotation) angle θ. The set turning angle θ is output to the variation curve calculator 23.

The input unit 22 is a unit for accepting an input of a detection value representing the light amount I of the detected light G from the photodetection sensor 34. The detection signal 35 of the detector 31 is input to the input unit 22. The input unit 22 obtains the detection value of the light amount I of the detected light G from the detection signal 35, and outputs the detection value to the variation curve calculator 23.

On the basis of the detection value of the light amount I of the detected light G, the variation curve calculator 23 calculates a variation curve Q representing periodic variation of the light amount I of the detected light G during one rotation of the detection-side polarizer 33. Specifically, the detected light G is light which is obtained when emission light E of the lamp 7 is successively passed through the wire grid polarizer 16 as a linear polarizer and the detection-side polarizer 33 in this order as shown in FIG. 3. There could be other elements between the detection-side polarizer 33 and the photodetection sensor 34. In one embodiments, there are a bandpass filter and focusing or imaging optical lenses between the detection-side polarizer 33 and the photodetection sensor 34.

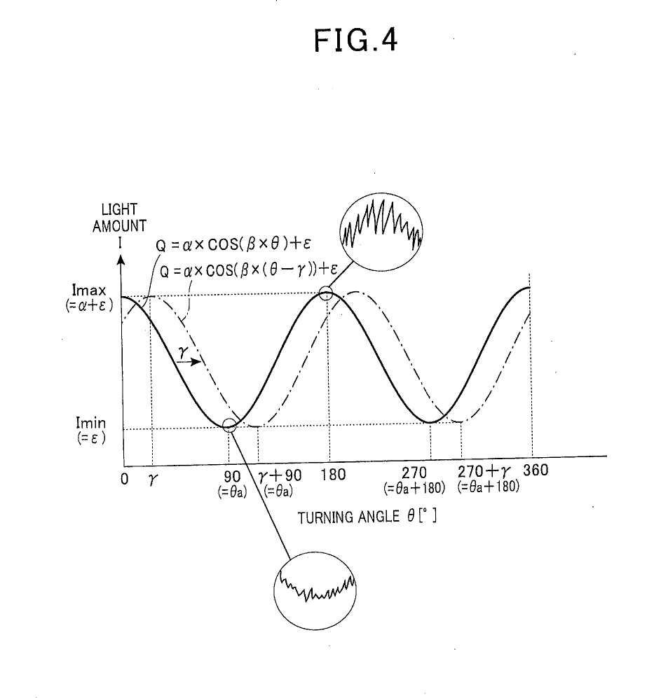

Accordingly, as shown in FIG. 4, the variation curve Q of the light amount I of the detected light G which is caused by the rotation of the detection-side polarizer 33 ideally has a cosine waveform which has a period of π[rad](=180°) and is represented by the following formula (1) (so-called Law of Malus). The variation curve Q having such a cosine waveform has the maximum light amount Imax (local maximum value) when the polarization axis C2 of the detection-side polarizer 33 is parallel to the polarization axis F1 of the polarized light F from the wire grid polarizer 16 (the turning angle θ=0°, 180° (local maximum points) in this embodiment), and has the minimum light amount Imin (local minimum value) when the polarization axis C2 is perpendicular to the polarization axis F1 of the polarized light F (the turning angle θ=90°, 270° (local minimum points) in this embodiment).

Variation Curve Q=α×cos(β×(θ−γ))+ε (1)

Here, α represents an amplitude, β represents a period, γ represents a phase displacement (the phase difference of the polarization axis F1 of the polarized light F from the reference position P0), and ε represents a bias component.

The variation curve calculator 23 determines the cosine waveform represented by the formula (1) on the basis of the detection value of the light amount I of the detected light G according to a curve fitting method (called as curvilinear regression), and outputs the determined cosine waveform to the polarization characteristic specifying unit 24.

When the polarization axis F1 of the polarized light F is displaced from the direction to the reference position P0, that is, the direction of the polarization axis C1 of the wire grid polarizer 16 is displaced from the arrangement direction B corresponding to the direction to the reference position P0, the displacement concerned appears as a phase displacement γ (>0) in the variation curve Q as illustrated by a virtual line (one-dotted chain line) in FIG. 4.

The polarization characteristic specifying unit 24 specifies the polarization direction of the polarized light F (that is, the direction of the polarization axis F1 of the polarized light F) and the extinction ratio on the basis of the variation curve Q determined by the variation curve calculator 23, and outputs them to the polarization characteristic output unit 25. Here, the extinction ratio is calculated by dividing the maximum light amount Imax by the minimum light amount Imin.

Specifically, the polarization characteristic specifying unit 24 determines “γ” corresponding to the turning angle θ (local maximum point) at which the maximum light amount Imax of the detected light G is obtained in the variation curve Q as shown in FIG. 4, thereby specifying the direction of the polarization axis C1, and also determines the extinction ratio (Imax/Imin=α) on the basis of the ratio between the maximum light amount Imax of the variation curve Q and the minimum light amount Imin of the variation curve Q. The maximum light amount Imax in the variation curve Q is determined by substituting the turning angle θ=γ (local maximum point) into the variation curve Q, and the minimum light amount Imin is determined by substituting the turning angle θ=90°+γ (local minimum point) into the variation curve Q.

The polarization characteristic output unit 25 outputs the polarization characteristics (the angle (direction) of the polarization axis (F1) and the extinction ratio of the polarized light F) specified by the polarization characteristic specifying unit 24. The manner of outputting the polarization characteristics may be arbitrary insofar as the polarization characteristics are available by a user. For example, the polarization characteristics may be displayed on a display unit, output to another electronic equipment, recorded into a recording medium or the like.

Here, individual differences may occur in the transmission characteristic of light due to characteristic variation, aged deterioration or the like of the detection-side polarizer 33 of the polarization measuring device 20. The dispersion of the transmission characteristic more remarkably appears in the minimum detected light amount as compared with the maximum detected light amount, which causes a great error in the extinction ratio.

Accordingly, it is preferable in the measurement of the extinction ratio by the polarization measuring device 20 that the minimum detected light amount measured by the polarization measuring device 20 is corrected to be equal to a minimum detected light amount which has been measured in advance by a reference polarization measuring device, and the extinction ratio is measured by using the corrected minimum detected light amount.

Inventors have obtained the following knowledge on the polarization characteristics through diligent theoretical considerations.

That is, when the extinction ratio of polarized light as a measurement target is high (the extinction ratio of the wire grid polarizer 16 is high), the measurement accuracy of the polarization axis is higher (the error of the polarization axis is lower). This is because of the following reason.

As described above, the angle (direction) of the polarization axis F1 of the polarized light F can be determined as an angle γ with respect to some reference position P0 (reference axis) by calculating the angle θ of the maximum light amount Imax in the variation curve Q.

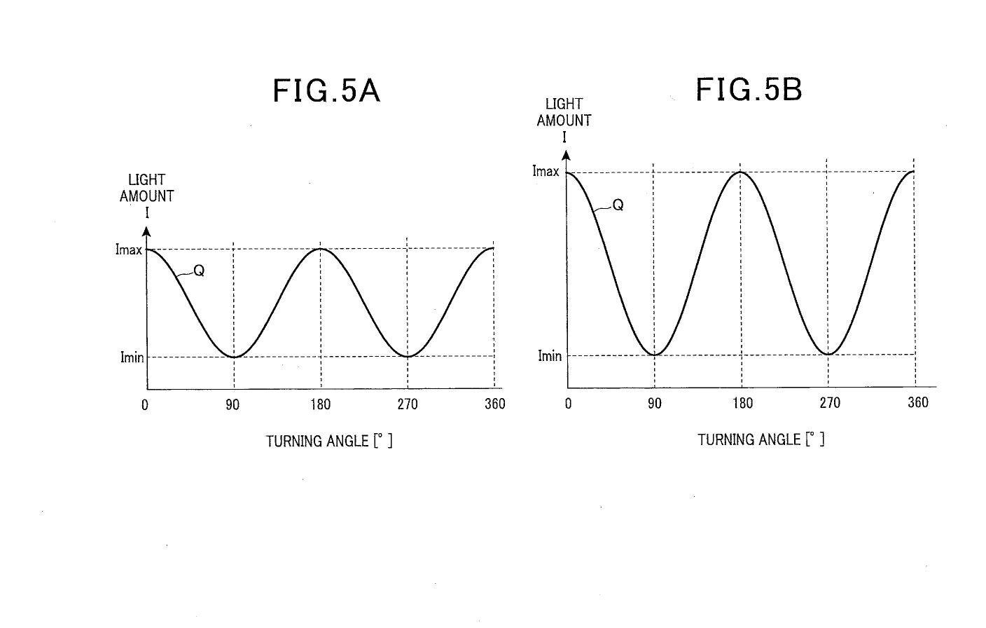

Here, the variation curve Q varies at a fixed period. Therefore, when the difference between the minimum light amount Imin and the maximum light amount Imax is small, the curvature of the variation curve Q at the local maximum points is small, and the variation curve Q is rounded as shown in FIG. 5A, so that the dispersion range of the angle θ at the local maximum points increases. In the case of the example shown in FIG. 5A, for example, the true value of the polarization axis F1 of the polarized light F is equal to 0.000°, but the measurement value obtained by the polarization measuring device 20 is equal to 0.01°.

On the other hand, when the difference between the minimum light amount Imin and the maximum light amount Imax is large, the curvature of the variation curve Q at the local maximum points is large, and the variation curve Q is sharp as shown in FIG. 5B, so that the dispersion range of the angle θ at the local maximum points is narrow and the angle θ concerned is determined with high precision. In the case of the example shown in FIG. 5B, the true value of the polarization axis F1 of the polarized light F is equal to 0.000°, but the measurement value obtained by the polarization measuring device 20 is equal to 0.003°. Therefore, the angle θ for the maximum light amount Imax can be determined with higher precision as compared with the example of FIG. 5A.

As described above, the maximum light amount Imax is divided by the minimum light amount Imin to calculate the extinction ratio. Therefore, as the extinction ratio of polarized light as a measurement target is increased, the angle θ can be determined with higher precision, and thus the polarization axis F1 of the polarized light F can be determined with higher precision.

The photo-alignment device 2 uses the discharge lamp 7 as the light source. Therefore, the brightness of the light source varies at a very short time period due to various factors such as fluctuation of the turn-on power of a power supply for turning on the lamp 7, the cooling state of the lamp 7, etc., and fluctuation and flickering occur in the light source. These fluctuation and flickering of the light source cause noise floor of the light source brightness. The noise floor components contain a long-term variation of the light source brightness which varies during a series of measurements performed to calculate the extinction ratio and the polarization axis, noise deriving from a sensor, noise deriving from the rotation accuracy of the stage, noise driving from leakage light which does not pass through the polarizer, noise caused by light which is passed through the polarizer and then reflected from an object while the polarization characteristic thereof changes to an unintentional characteristic, etc. An output which does not derive from the performance of the polarizer, but appears in the sensor output as described above is also defined as a noise floor component. Since the extinction ratio is defined by dividing the maximum light amount Imax by the minimum light amount Imin, the effect of the noise component on the value of the extinction ratio is reduced as the rate (percentage) of (the noise component/the minimum light amount Imin) is smaller.

A polarizer having a higher extinction ratio than that of the wire grid polarizer 16 has been heretofore used as the detection-side polarizer 33. Therefore, the extinction ratio of the polarized light is substantially dependent on the wire grid polarizer 16 as the adjustment target.

Accordingly, according to this embodiment, the extinction ratio of polarized light which is incident to and measured by the polarization measuring device 20 can be set to a high value by setting the extinction ratio of the wire grid polarizer 16 to a high value. In this embodiment, it is needless to say that the extinction ratio of the detection-side polarizer 33 is also set to be higher than the extinction ratio of the wire grid polarizer 16.

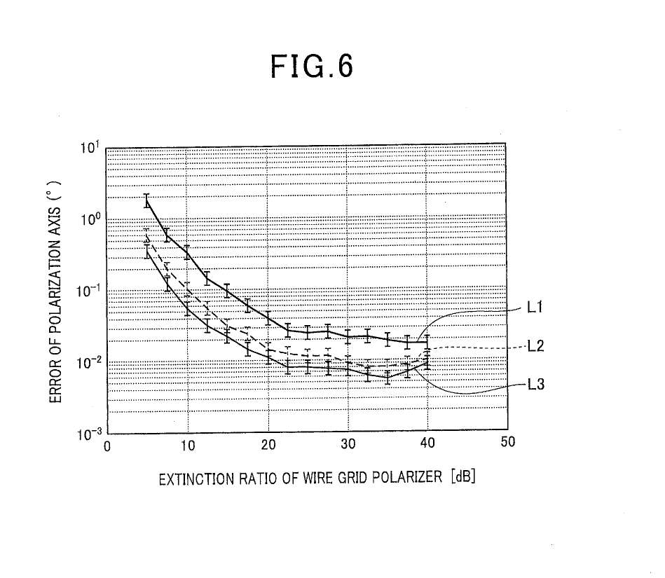

FIGS. 6 to 8 are graphs showing the relationship between the extinction ratio of the wire grid polarizer 16 and the error of the polarization axis F1 of the polarized light F measured by the polarization measuring device 20.

Here, the extinction ratio is also represented by “decibel (dB)” in spite of “ratio”, and the dB value of the extinction ratio is calculated according to the following conversion equation (2) using fraction E_{T}.

Extinction ratio, dB=10·log₁₀E_{T} (2)

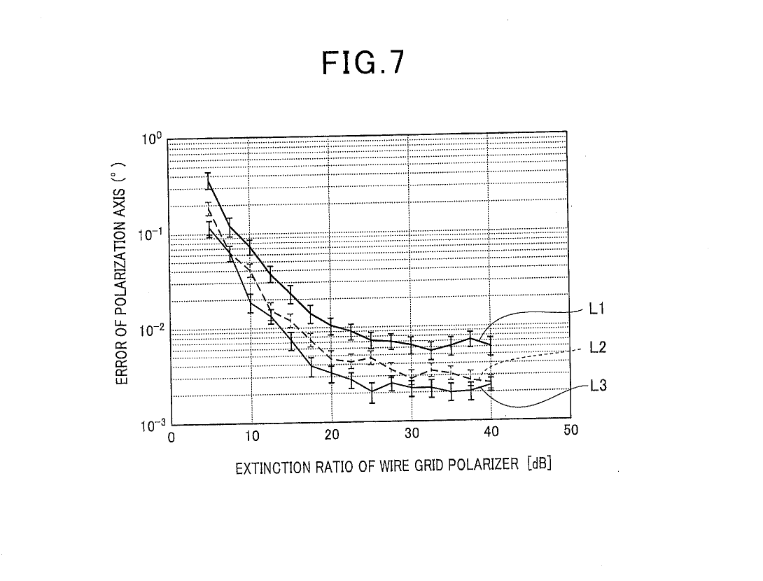

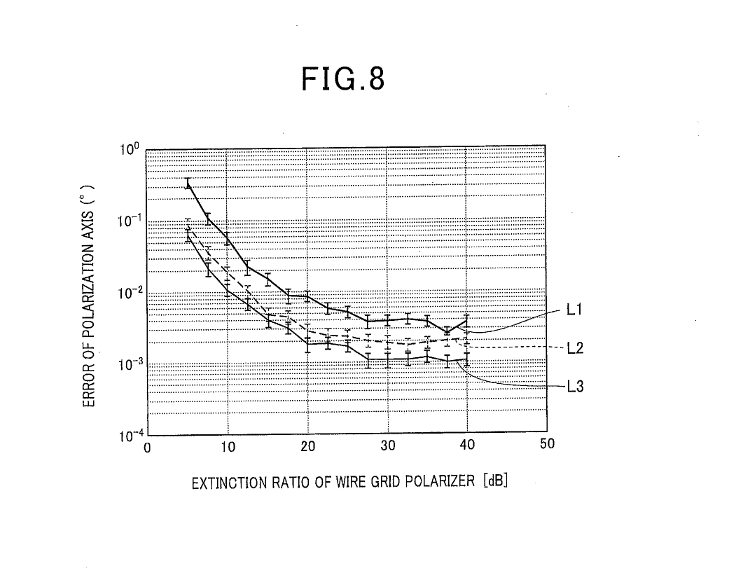

In measurements for measurement results shown in FIGS. 6 to 8, the extinction ratio of the detection-side polarizer 33 is equal to 50 (dB), the P-polarization transmittance is equal to 60(%), and the number of calculation trials for determining the error of the polarization axis is equal to 100 (times). FIG. 6 shows the result when the noise floor is equal to 35 (dB), FIG. 7 shows the result when the noise floor is equal to 45 (dB) and FIG. 8 shows the result when the noise floor is equal to 50 (dB). In FIGS. 6 to 8, the abscissa axis represents the extinction ratio of the wire grid polarizer 16, and the ordinate axis represents the error (the error of the phase difference γ) of the polarization axis F1 of the polarized light F to the true value. Furthermore, lines L1, L2 and L3 in FIGS. 6 to 8 represent results (the measurement errors of the polarization axis) when the division number in the angular direction for actual measurement points of the variation curve Q for calculating the extinction ratio and the polarization axis descried above are varied. For example, the line L1 represents the result for the division number of 30 (namely, the number of points used on the curves in FIGS. 4, 5A and 5B), the line L2 represents the result for the division number of 240 and the line L3 represents the result for the division number of 810. Therefore, it is obvious to person knowledgeable in this art that a device-side polarizer of extinction ratio 100:1 or more also improves measuring speed as well.

As shown in FIGS. 6 to 8, as the extinction ratio of the wire grid polarizer 16 is higher, the error of the polarization axis F1 of the measured polarized light F is smaller. When the extinction ratio increases to about 20 dB (100:1) or more, the variation amount of the error of the polarization axis F1 of the measured polarized light F moderates.

In order to adjust the polarization axis with an accuracy rate of 0.1° or less in error, the measurement accuracy of 0.01° or less in error is required. In the examples shown in FIGS. 7 and 8, when the extinction ratio increases to about 20 dB (100:1) or more, the error is reduced to a target error (0.01°) or less.

In this embodiment, the extinction ratio of the wire grid polarizer 16 is set to 1:100 or more. The extinction ratio of the detection-side polarizer 33 is set to be higher than the extinction ratio of the wire grid polarizer 16. Furthermore, the upper limit of the extinction ratio which is measurable by the polarization measuring device 20 is set to 1000:1. In this embodiment, the calculation is performed on the assumption that the light has a single wavelength (for example, 254 nm). However, the same concept is applicable to a light source for emitting light having multiple wavelengths (for example, high-pressure mercury lamp, metal halide lamp, etc.).

Accordingly, the dispersion range of the angle θ at the local maximum points narrows when extinction ratio of polarizer 16 is higher, and the angle (direction) of the polarization axis F1 of the polarized light F can be measured with high precision.

Next, the measurement of the polarized light of the photo-alignment device 2 by using the polarization measuring mechanism will be described.

A worker first sets up the measurement unit 30 in the photo-alignment device 2. When the measurement unit 30 is set up in the photo-alignment device 2, the worker sets up the linear guide 32 so that the guide direction of the linear guide 32 is parallel to the arrangement direction B of the wire grid polarizers 16 and the linear guide 32 is located just under the polarization unit 10. Subsequently, the worker operates the linear guide 32 to guide the detector 31 and locate the detector 31 just below a wire grid polarizer 16 as a measurement target, and detects the polarized light F emitted from the wire grid polarizer 16 by using the polarization measuring mechanism to measure the polarization axis C1 of the wire grid polarizer 16 and the extinction ratio. On the basis of the measurement result of the polarization axis F1 of the polarized light F, the worker finely adjust the turning (rotation) of the wire grid polarizer 16 as occasion demands, whereby the direction of the polarization axis C1 is aligned with a predetermined direction (the arrangement direction B in this embodiment).

The worker likewise performs the work of measuring the polarized light F and aligning the direction of the polarization axis C1 with the arrangement direction B on the basis of the measurement results for all the wire grid polarizers 16 of the polarizer unit 10, whereby the directions of the polarization axes C1 of all the wire grid polarizers 16 are aligned with the arrangement direction B.

As described above, according to the polarization measuring mechanism 1, the direction of the polarization axis C1 is specified from the variation curve Q with high precision. Therefore, the direction of the polarization axis F1 of the polarized light F can be adjusted with high precision when each wire grid polarizer 16 is individually finely adjusted.

As described above, according to this embodiment, the polarization measuring device 20 for measuring the polarization axis F1 of the polarized light F is provided, and the extinction ratio of the wire grid polarizer 16 (the device-side polarizer) is set to 100:1 or more. Specifically, the polarization measuring device 20 has the detection-side polarizer 33, and detects light transmitted through the wire grid polarizer 16 and the detection-side polarizer 33 in this order while changing the polarization-axis angle of the detection-side polarizer 33, thereby detecting the light amount of the light at each polarization-axis angle of the detection-side polarizer 33, determine, on the basis of the light amount at each polarization-side angle, a variation curve Q which represents a periodical variation of the light amount when the polarization-axis angle of the detection-side polarizer 33 is changed, and calculate the polarization axis F1 of the polarized light F from the variation curve Q. According to this construction, the angle θ of the variation curve Q can be determined with high precision, and thus the polarization axis F1 of the polarized light F can be determined with high precision.

Furthermore, according to this embodiment, the polarization measuring device 20 changes the polarization axis angle of the detection-side polarizer 33 by turning (rotating) the detection-side polarizer 33. According to this construction, the polarized light can be measured by using one detection-side polarizer 33, so that the polarization measuring device 20 can be simplified and miniaturized.

The embodiment described above is an example of the present invention, and any modification and application may be made without departing from the subject matter of the present invention.

For example, in the above embodiment, the lamp 7 as the discharge lamp 7 is used as the light source for polarized light to be measured by the polarization measuring mechanism 1. However, the light source is not limited to the discharge lamp, and any light source may be used. The present invention is applicable to measure linearly polarized light obtained by linearly polarizing light from any light source while transmitting the light through a polarizer. Furthermore, the light source is not necessarily limited to a linear light source.

Furthermore, in the above embodiment, the wire grid polarizer 16 is exemplified as an example of the polarizer for obtaining polarized light as a measurement target. However, the polarizer is not limited to the wire grid polarizer. That is, any polarizer may be used insofar as the polarizer obtains linearly polarized light.

In the above embodiment, the polarization measuring device 20 is configured to measure both the polarization axis and extinction ratio of the polarized light. However, the polarization measuring device 20 may measure only the polarization axis. Furthermore, the polarization measuring device 20 may measure other characteristics such as light intensity, etc. in addition to the polarization axis of the polarized light.

Furthermore, in the above embodiment, the polarization measuring device 20 obtains the light amount of the detection light G by inputting the detection signal 35 of the detector 31 into the polarization measuring device 20. However, the present invention is not limited to this style. That is, recording data representing the association between the turning (rotation) angle θ and the light amount of the detection light G may be obtained from another electronic equipment or a recording medium (for example, a semiconductor memory or the like).

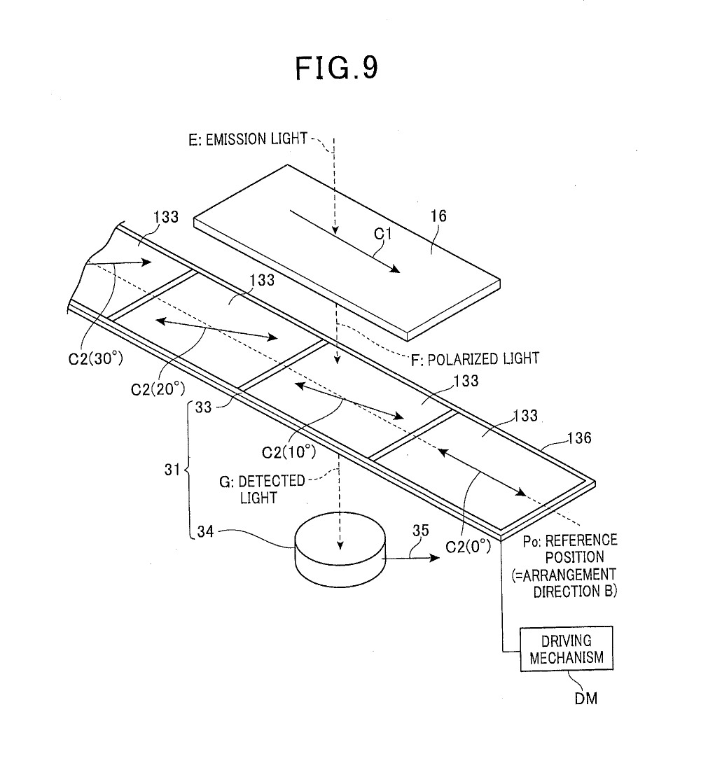

In the above embodiment, the angle (direction) of the polarization angle C2 of the detection-side polarizer 33 is changed by turning (rotating) the detection-side polarizer 33. However, the method of changing the angle (direction) of the polarization axis C2 of the detection-side polarizer 33 is not limited to the above method. For example, as shown in FIG. 9, the detection-side polarizer 33 may be configured to have plural detection-side polarizers 133 which have different polarization-axis angles (directions) with respect to the arrangement direction B, and these plural detection-side polarizers 133 may be moved, for example, so that each detection-side polarizer 133 is passed or located just under a wire grid polarizer 16 as a measurement target in series, thereby changing the angle (direction) of the polarization axis C2 at the detection side. In this case, the variation curve Q as shown in FIG. 4 is also obtained. Accordingly, an accuracy is not required for rotation/stop of the detection-side polarizer 33, and the polarization measuring device 20 can be constructed at low cost.

In the example of FIG. 9, the plural detection-side polarizers 133 whose polarization axes C2 are different, for example, at an angular interval of 10°, are provided on a frame 136 to be arranged in a line on the same straight line, and the frame 136 is linearly moved in the arrangement direction B. However, the angles of the polarization axes C2 of the detection-side polarizers 133, and the arrangement direction and moving direction of the detection-side polarizers 13 are not limited to those of the example of FIG. 9. For example, plural detection-side polarizers may be disposed on the frame so as to be arranged on the same circle, and the frame may be rotated (turned).

The manner of moving the plural detection-side polarizers is not limited to a specific manner. For example, the plural detection-side polarizers may be moved sequentially (continuously or intermittently) to change the angle of the polarization axis C2 with a driving mechanism DM such as a rotary actuator, a combination of a gear and a motor or other publicly known moving devices.

1. A light irradiation device for irradiating polarized light comprising:
a light source;
a device-side polarizer that polarizes light of the light source, the device-side polarizer having an extinction ratio of 100:1 or more at one or more wavelengths of light; and
a measuring device that determines a polarization axis of the light polarized by the device-side polarizer, wherein the measuring device may be moved away or separated from the rest of the light irradiation device.

2. The light irradiation device according to claim 1, wherein the measuring device has a detection-side polarizer, and the measuring device detects light transmitted through the device-side polarizer and the detection-side polarizer in this order while changing a polarization-axis angle of the detection-side polarizer, obtains a variation curve representing a periodical variation of a light amount of the light detected while changing the polarization-axis angle of the detection-side polarizer, and determines the polarization axis of the device-side polarizer on the basis of the variation curve.

3. The light irradiation device according to claim 2, wherein the measuring device changes the polarization-axis angle of the detection-side polarizer by turning the detection-side polarizer.

4. The light irradiating device according to claim 3, further comprising a rotary actuator that turns the detection-side polarizer to change the polarization-axis angle of the detection-side polarizer.

5. The light irradiation device according to claim 2, wherein the measuring device has a plurality of detection-side polarizers having different polarization-axis angles at a detection side, and the polarization-axis angle at the detection side is changed by moving the plurality of detection-side polarizers while making the light transmitted through the device-side polarizer pass through each of the detection-side polarizers in series.

6. A light irradiation device for irradiating polarized light comprising:
a light source;
a device-side polarizer that polarizes light of the light source along a polarization axis thereof and has an extinction ratio of 100:1 or more;
a detection-side polarizer that transmits the light polarized by the device-side polarizer; and
a polarization-axis detector that detects light transmitted through the device-side polarizer and the detection-side polarizer in this order while changing a polarization-axis angle of the detection-side polarizer, obtains a variation curve representing a periodical variation of a light amount of the light detected at each polarization-axis angle of the detection-side polarizer, and determines a polarization-axis angle of the device-side polarizer on the basis of the variation curve.

7. The light irradiation device according to claim 6, wherein the polarization-axis detector has a plurality of detection-side polarizers having different polarization-axis angles at a detection side, and a driving mechanism that moves the plurality of detection-side polarizers while making the light transmitted through the device-side polarizer pass through each of the detection-side polarizers in series, thereby changing the polarization-axis angle at the detection side.

8. A light irradiation device for irradiating polarized light comprising:
a light source; and
more than one device-side polarizer that polarizes light of the light source with an extinction ratio value of at least 100:1 at one or more wavelengths of the light, wherein the device-side polarizers are aligned to a predetermined polarization directions within 0.1 deg. or less in error.

9. The light irradiation device according claim 8, wherein the direction of the polarization direction may be determined by a measuring device that is used to determine a polarization axis of the light polarized by each of the device-side polarizers, and may be moved away or separated from the light irradiation device.
